(19) United States
(12) Patent Application Publication
(10) Pub. No.: US 2013/0343967 A1
(43) Pub. Date: Dec. 26, 2013

(54) DEVICE FOR CENTRIFUGATION AND FURTHER PROCESSING OF TISSUE ASPIRATES IN CLOSED SYSTEM

(71) Applicants: Viktor Izápy, Budapest (HU); Miklós Weszl, Budapest (HU); Zsombor Lacza, Csopak (HU)

(72) Inventors: Viktor Izápy, Budapest (HU); Miklós Weszl, Budapest (HU); Zsombor Lacza, Csopak (HU)

(73) Assignee: LACERTA TECHNOLOGIES INC., Winston-Salem, NC (US)

(21) Appl. No.: 13/978,015

(22) PCT Filed: Jan. 6, 2011
(86) PCT No.: PCT/HU2011/000002

§ 371 Date: Sep. 16, 2013

(51) Int. Cl. B04B 7/08

(52) U.S. Cl. CPC B04B 7/08
USPC 422/548

(57) ABSTRACT

The device enables to put the patients own bone marrow derived stem cells on a lyophilized bone allograft covered by human albumin, after a short separation by centrifugation. The cell concentrator comprises a closed housing (1, 2) for receiving a syringe (7) for holding tissue aspirates and a container (12) below said syringe (7) for receiving the concentrate received by centrifugation; means for clamping the syringe within said housing (1, 2); means for releasable locking the plunger (6) of the syringe (7) and means for pushing the plunger (6) of the syringe (7) along a predetermined length, to introduce at least a part of the concentrate into said container (12). The built-in pushbutton mechanism designed to spray the proper amount of stem cell rich fluid to the surface of the bone graft.

### FIELD OF THE INVENTION

The present invention relates to a device for centrifugation and further processing of tissue aspirates in closed system, preferably for producing and processing stem cell or bone marrow concentrates, platelet rich plasmas or the like.

### BACKGROUND OF THE INVENTION

There are solutions for stem cell separation, creating bone marrow concentrate or platelet rich plasma, but these solutions have some disadvantages.

The device called Thermogenesis Marrow Xpress (US 2007/015560: Stem and progenitor cell compositions recovered from bone marrow or cord blood; system and method for preparation thereof) is used for harvesting stem cells from bone marrow. The device is rather complicated, and contains a large number of constructional elements. For carrying out the separation, a special centrifuge rotor and centrifuge is needed.

Another way for producing a stem cell concentrate is offered by Tehermogenesis care system Res-Q™ 60 BMC. It is a simple closed system, comprising disposable parts made especially for this device. Centrifugation is needed for separating the different fractions of the fluid in the device.

Another device called CAPTION Disposable Platelet Concentrator (Smith & Nephew) makes platelet rich plasma from blood, and the plasma can be absorbed in some kind of bone graft. There is no need of a centrifuge or external energy source for the separation. Filtration is used, and a pump to create platelet rich plasma. However, the device can be used only once, and therefore, a new device is needed for every blood processing operation.

U.S. Pat. No. 3,468,927 discloses a syringe-supporting device for centrifuges, comprising a cylindrical sleeve and means for connecting said sleeve to a centrifuge. In the sleeve there are two identical half-shells for retaining a syringe employed for sampling blood to be centrifuged. Internal grooves are provided in the half-shells for locking the cylinder of the syringe, and another internal groove for locking the plunger of the syringe in the position corresponding to the quantity of blood taken.

However, the device can only used for centrifugation of blood or other tissue aspirates, for separating different fractions. Processing of the concentrate, if needed, can only carried out in other devices.

### BRIEF DESCRIPTION OF THE INVENTION

Object of the present invention is therefor to provide a device, which can be used not only for the separation process, but for fast and clear processing of tissue aspirates, e.g. for bone marrow preparation in a closed system.

According to an aspect of the present invention, the device comprises
a closed housing to receive a syringe for holding tissue aspirates and a container below said syringe for receiving the concentrate received by centrifugation;
means for clamping the syringe within said housing;
means for releasable locking the plunger of the syringe and
means for pushing the plunger of the syringe along a predetermined length, to introduce at least a part of the concentrate into said container.

The housing is preferably made of at least two parts: a first part for receiving and clamping the syringe and the container, and a second part provided with means for releasable locking the plunger and with means for pushing the plunger.

The means for clamping the syringe may be among others a bayonet lock or a clipper.

The means for releasable locking the plunger may comprise screws arranged radially in the wall of the housing or may be a clip insert.

The means for pushing the plunger may contain a push button supported by spring or a lever supported by spring or any other known means.

According to a preferred embodiment, the parts of the housing are connected to each other by bayonet lock. According to another embodiment the parts of the housing are in threaded connection.

The device is provided with means for connection with a centrifuge, such as pins on the housing or a shoulder on the wall of the housing.

The main advantage of the device according to the invention is that, upon centrifugation, the user can inject e.g. stem cells onto the surface of a bone graft by a single thumb movement. Another advantage of this solution is, that the device is built from standardized, widely accessible parts (containers, septums, needles, syringes etc.), which are available in every hospital, in every operating room. The housing may be sterilized after use, the only disposables are the syringes, needles and containers, which are single use products anyway.

The device may be assembled and disassembled easily, the shape and size contributes to the easy use of the device.

### BRIEF DESCRIPTION OF THE DRAWINGS

Other advantages and features of the invention will be described in the following description of preferred embodiments, with reference to the accompanying drawings, in which

FIG. 1. is a view in partial section of a preferred embodiment of the device according to the invention;

FIG. 2. is a detail of the upper part of another embodiment;

FIG. 3. is section III-III of FIG. 2; and

FIG. 4. is the perspective view of the device in FIG. 1.

### DESCRIPTION OF A PREFERRED EMBODIMENT

The device is a kind of a centrifugal separator which separates different stem cell related materials with centrifugation. The material samples are held in different kinds of containers, and the containers are arranged in one single unit: a capsule shape housing.

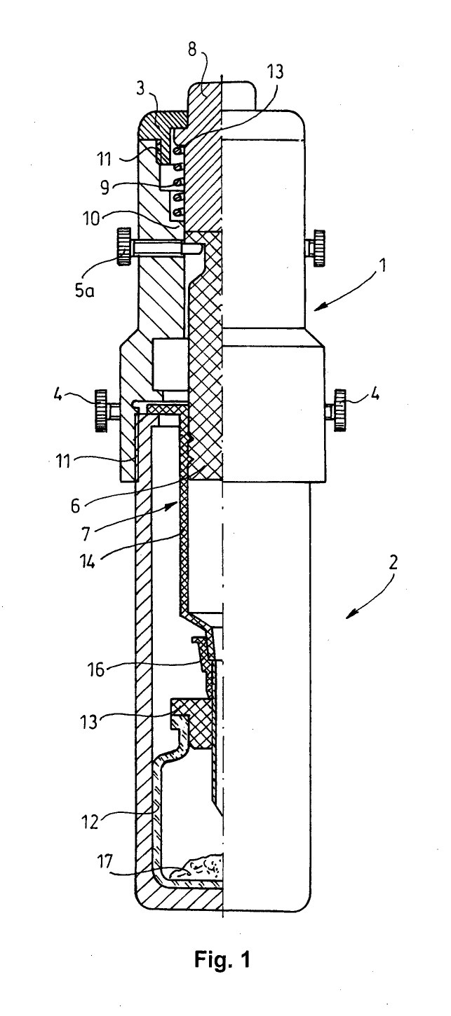

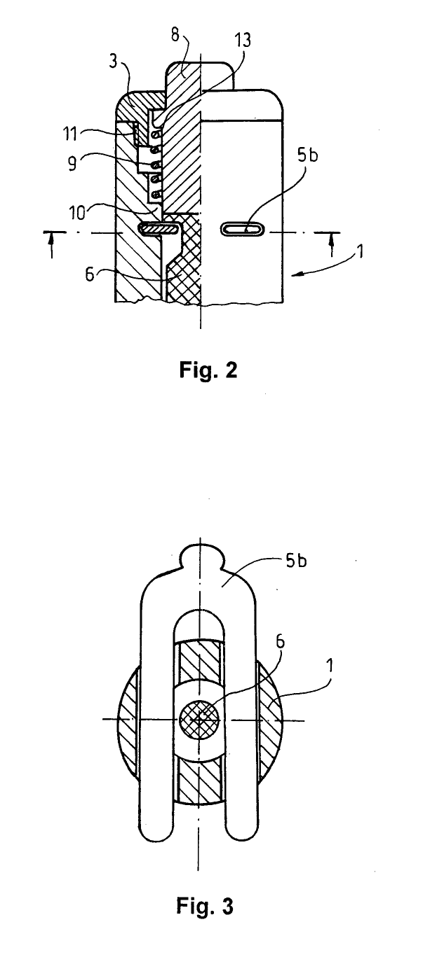

FIGS. 1 and 2 show a preferred embodiment of the device according to the invention. The housing contains according to this embodiment three main parts: an upper part 1, a lower part 2, and a cap 3. One of parts 1 and 2 is provided with pins 4 for connection to a centrifuge rotor (not shown). However, the connection means may be a shoulder on the wall of the housing as well.

There are four fastening screws 5a in the upper part 1 of the housing for locking the plunger 6 of a syringe 7. The cap 3 provided at the top of the housing is receiving a push button 8 and a spring 9 arranged between said cap and an inner shoulder 10 of the upper part of the housing. The cap 3 may be connected to the upper part 1 of the housing with threads or a bayonet-joint, but persons skilled in the art can use many other known structural elements. Similar constructions may be used for the connection between the housing parts 1 and 2. FIG. 1 shows a threaded connection 11.

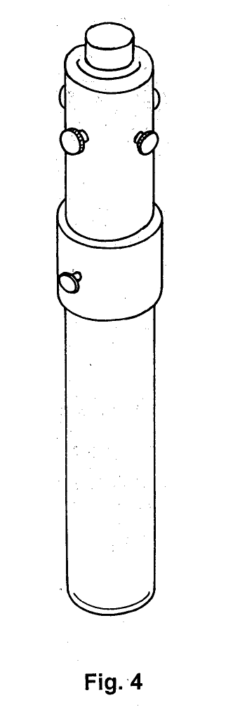

The four fastening screws 5a shown in FIG. 1. lock the plunger 6 of the syringe during centrifugation. However, many other known elements may be applied for locking the plunger as well. Means for locking the plunger may be e.g. an elastic clip insert 5b shown in FIGS. 2 and 3, or any other known element.

The lower part of the housing is shaped for receiving a container 12 which is sealed with a septum 13. Above the container, the cylinder 14 of the syringe 7 is locked between the lower and upper parts of the housing, by known elements, e.g. bayonet lock or thread. A threaded connection 15 is shown for this purpose in FIG. 1. There is a needle 16 between the container 12 and the syringe 7. The septum 13 of container 12 is lanced through by the needle (cannula) 16 of the syringe 7 before parts 1 and 2 are connected to each other.

During the use of the device, a container containing an appropriate material 17, e.g. bone graft is arranged in the lower part of the device. The tissue aspirate to be processed is filled to the syringe provided with the cannula. Then, the septum of the container is pierced through by the cannula and the syringe is locked in the lower part or between the upper and lower part. At the same time, the plunger of the syringe is locked in the upper part of the housing by the fixing screws (5a in FIG. 1.) or inserting the elastic clip insert (5b in FIGS. 2 and 3).

The device is then brought above a centrifuge. The rotary motion of the centrifuge causes separation of the fractions of the tissue aspirate, and the concentrate remains in the cylinder of the syringe at the outlet to the needle. The device is withdrawn from the centrifuge, the fixing screws are released or elastic clip insert 5b is removed, and the plunger is activated by the push button. Due to this movement, appropriate amount of the concentrate flows into the container, wherein the desired reaction is started/going on. The appropriate amount of tissue aspirates may be adjusted by the stroke length of the push button.

It is to be noted, that the device described above in this disclosure is only a preferred embodiment of the invention and by no means is limiting the scope claimed. Persons skilled in the art can apply a great number of variants, and modifications could in any case be made in the embodiment disclosed without departing from the scope or the spirit of the invention. Further to the different variations of locking the plunger or the syringe, the activation of the plunger can also be solved in different ways. Instead of the push button, e.g. levers or high pitch threads may be applied. The housing may also have more, then two parts, and the connection between the parts may have many different forms as well.

All the disclosed and non disclosed embodiments of the present invention offer the main advantage of using a single device for centrifugation and further processing of tissue aspirates in a simple, closed and safe way.

What we claim is:

1. Device for centrifugation and further processing of tissue aspirates in closed system, preferably for producing and processing stem cell or bone marrow concentrates, platelet rich plasmas or the like, the device comprising
a closed housing (1, 2) for receiving a syringe (7) for holding said tissue aspirates and a container (12) below said syringe (7) for receiving the concentrate received by centrifugation;
means for clamping the syringe within said housing (1, 2);
means for releasable locking the plunger (6) of the syringe (7) and
means for pushing the plunger (6) of the syringe (7) along a predetermined length, to introduce at least a part of the concentrate into said container (12).

2. The device as claimed in claim 1, wherein the housing is made of at least two parts: a first part (1) for receiving the syringe (7) and the container (12), and a second part (2) provided with means for releasable locking the plunger (6) and means for pushing the plunger (6).

3. The device as claimed in claim 1, wherein said means for clamping the syringe (7) is a threaded connection (11).

4. The device as claimed in claim 1, wherein said means for clamping the syringe (7) is a bayonet lock.

5. The device as claimed in claim 1, wherein said means for releasable locking the plunger (6) comprises screws (5a) arranged radially in the wall of the housing (1).

6. The device as claimed in claim 1, wherein said means for releasable locking the plunger (6) is a clip insert (5b) to be inserted and removed into and out of the housing.

7. The device as claimed in claim 1, wherein said means for pushing the plunger (6) contains a push button (8) supported by a spring (9).

8. The device as claimed in claim 2, wherein the parts (1, 2) of the housing are connected to each other by bayonet lock.

9. The device as claimed in claim 2, wherein the parts (1, 2) of the housing are in threaded connection (11).

10. The device as claimed in claim 1, wherein the housing (1, 2) is provided with means for connection with a centrifuge.

11. The device as claimed in claim 10, wherein said means for connection with a centrifuge comprises pins (4) on the housing.

12. The device as claimed in claim 10, wherein said means for connection with a centrifuge is a shoulder on the wall of the housing.
